(19) United States
(12) Patent Application Publication
(10) Pub. No.: US 2016/0221379 A1
(43) Pub. Date: Aug. 4, 2016

(54) FLEXO PRINTING PLATE

(71) Applicant: FUJIFILM Corporation, Tokyo (JP)

(72) Inventors: Yusuke NAMBA, Haibara-gun (JP); Seiichiro MORIKAWA, Haibara-gun (JP); Hiroshi TASHIRO, Haibara-gun (JP)

(73) Assignee: FUJIFILM Corporation, Tokyo (JP)

(21) Appl. No.: 15/091,663

(22) Filed: Apr. 6, 2016

Related U.S. Application Data
(63) Continuation of application No. PCT/JP2014/077415, filed on Oct. 15, 2014.

(30) Foreign Application Priority Data
Oct. 17, 2013 (JP) 2013-216494

(51) Int. Cl. B41N 1/12

(52) U.S. Cl. CPC B41N 1/12

(57) ABSTRACT

Provided is a flexo printing plate which enables printing that inhibits the occurrence of voids in the rear end portion of an image portion while preventing decrease in solid density and prevents discontinuity of density from becoming visible. The flexo printing plate has one or more image portions, and in at least one of the image portions, a plurality of depressions having a predetermined width measured from the edge is formed. The depressions have a depth of 2 μm to 9 μm, and an area ratio of the depressions in the end region is a maximum at the edge side and a minimum at the central side of the image portion.

### CROSS-REFERENCE TO RELATED APPLICATIONS

This application is a Continuation of PCT International Application No. PCT/JP2014/077415 filed on Oct. 15, 2014, which claims priority under 35 U.S.C. §119(a) to Japanese Patent Application No. 2013-216494 filed on Oct. 17, 2013. The above application is hereby expressly incorporated by reference, in its entirety, into the present application.

### BACKGROUND OF THE INVENTION

1. Field of the Invention

The present invention relates to a flexo printing plate.

2. Description of the Related Art

A flexo printing plate having a flexible relief forming layer made of a resin or rubber has relatively soft projections (image portions) for printing and can conform to various shapes. Therefore, a flexo printing plate is used for printing performed on printing targets made of various materials, thick printing targets, and the like.

During the flexo printing performed using such a flexo printing plate, the flexo printing plate is loaded onto the peripheral surface of a cylindrical drum, and while a roller is being rotated, the flexo printing plate is brought into contact with a printing target. In this way, ink is directly transferred to the printing target from the surface of projections (image portions) of the printing plate, and an image is formed on the printing target.

At this time, transfer failure of the ink may occur at the rear end portion of the image portions in the printing direction (rotation direction), and this leads to a problem of the occurrence of voids in the formed image.

As a solution to this problem, US2010/0224091A describes that the occurrence of voids at the rear end portion of the image is reduced by forming sunken patterns in the rear end portion of a flexo printing plate.

Meanwhile, U.S. Pat. No. 7,580,154B describes that for preventing the decrease in ink density in a solid region, patterns of depressions (ink cells) for holding the ink in image portions of a printing plate are formed.

### SUMMARY OF THE INVENTION

As a result of conducting investigation, the inventors of the present invention found that in a case where uniform sunken patterns are formed in the rear end portion of a printing plate as described in US2010/0224091A, a problem occurs in that discontinuity of the boundary between a region where the patterns arc formed and a solid region is confirmed in the printed image.

Furthermore, the inventors found that in a case where uniform patterns are formed in the image portions as described in US7580154B, a problem such as a decrease in solid density occurs.

Therefore, an object of the present invention is to provide a flexo printing plate which enables printing that inhibits the occurrence of voids in the rear end portion of image portions while preventing the decrease in solid density and prevents the discontinuity of density from becoming visible.

In order to achieve the above object, the inventors of the present invention conducted intensive research. As a result, they obtained knowledge that by adopting a constitution in which a plurality of depressions is formed in an end region having a predetermined width measured from the edge in an image portion; the depressions have a depth of 2 μm to 9 μm; and an area ratio of the depressions in the end region is a maximum at the edge side and a minimum at the central side of the image portion, it is possible to perform printing which inhibits the occurrence of voids in the rear end portion of the image portions while preventing the decrease in the solid density and prevents the discontinuity of density from becoming visible. Based on the knowledge, the inventors accomplished the present invention.

That is, the present invention provides a flexo printing, plate constituted as below.

(1) A flexo printing plate having one or more image portions, in which in at least one of the image portions, a plurality of depressions is formed in an end region having a predetermined width measured from the edge, the depressions have a depth of 2 μm to 9 μm, and an area ratio of the depressions in the end region is a maximum at the edge side and a minimum at the central side of the image portion.

(2) The flexo printing plate described in (1), in which the width of the end region is 0.1 μm to 600 μm.

(3) The flexo printing plate described in (1) or (2), in which in the end region, the area ratio of the depressions decreases in stages as the depressions become further away from the edge.

(4) The flexo printing plate described in any one of (1) to (3), in which each of the depressions has an opening area of 25 μm² to 2,500 μm².

(5) The flexo printing plate described in any one of (1) to (4), in which the end region has a plurality of partial regions having different area ratios such that the area ratio of the depressions decreases in stages as the depressions become further away from the edge, and the area ratio of the depressions in a partial region coming into contact with the edge is equal to or greater than 11% and equal to or less than 54%.

(6) The flexo printing plate described in any one of (1) to (5), in which the end region has a plurality of partial regions having different area ratios such that the area ratio of the depressions decreases in stages as the depressions become further away from the edge, and a difference in the area ratio of the depressions between partial regions adjacent to each other is equal to or less than 9%.

(7) The flexo printing plate described in any one of (1) to (6), in which the end region is formed at the rear end portion side in a printing direction.

According to the present invention, it is possible to provide a flexo printing plate which enables printing that prevents the occurrence of voids in the rear end portion of image portions while inhibiting a decrease in solid density and prevents the discontinuity of density from becoming visible.

### BRIEF DESCRIPTION OF THE DRAWINGS

FIG. 1A is a front view schematically showing an example of a flexo printing plate according to the present invention, and FIG. 1B is a sectional view taken along the line b-b of FIG. 1A.

FIG. 2A is a partially enlarged view showing a portion of an image portion of the flexo printing plate shown in FIG. 1A through enlargement, and FIG. 2B is a partially enlarged view showing an example of another image portion of the flexo printing plate shown in FIG. 1A through enlargement.

FIG. 3A is a front view schematically showing a portion of an end region of the flexo printing plate shown in FIG. 1A through enlargement, and FIG. 3B is a sectional view take along the line e-e of FIG. 3A.

FIG. 4 is a graph schematically showing the relationship between an area ratio and a distance from the edge.

FIGS. 5A to 5D are partially enlarged views each showing the surface of a partial region through enlargement.

FIG. 6 is a flow chart showing an example of a method for generating image data at the time of manufacturing a printing plate.

FIG. 7 is a view schematically showing main portions of a flexo printing apparatus using the flexo printing plate according to the present invention.

FIG. 8A is a view schematically showing an example of an image portion of a printing plate, and FIG. 8B is a partially enlarged view showing an end region of FIG. 8A through enlargement.

### DESCRIPTION OF THE PREFERRED EMBODIMENTS

[Flexo Printing Plate]

The flexo printing plate (hereinafter, simply referred to as a “printing plate” as well) according to the present invention is a flexo printing plate in which in an end region having a predetermined width measured from the edge in an image portion, depressions having a depth of 2 μm to 9 μm are formed as patterns such that an area ratio of the depressions becomes maximum at the edge side and minimum at the central side of the image portion.

Hereinafter, the constitution of the flexo printing plate according to the present invention will be specifically described based on the attached drawings.

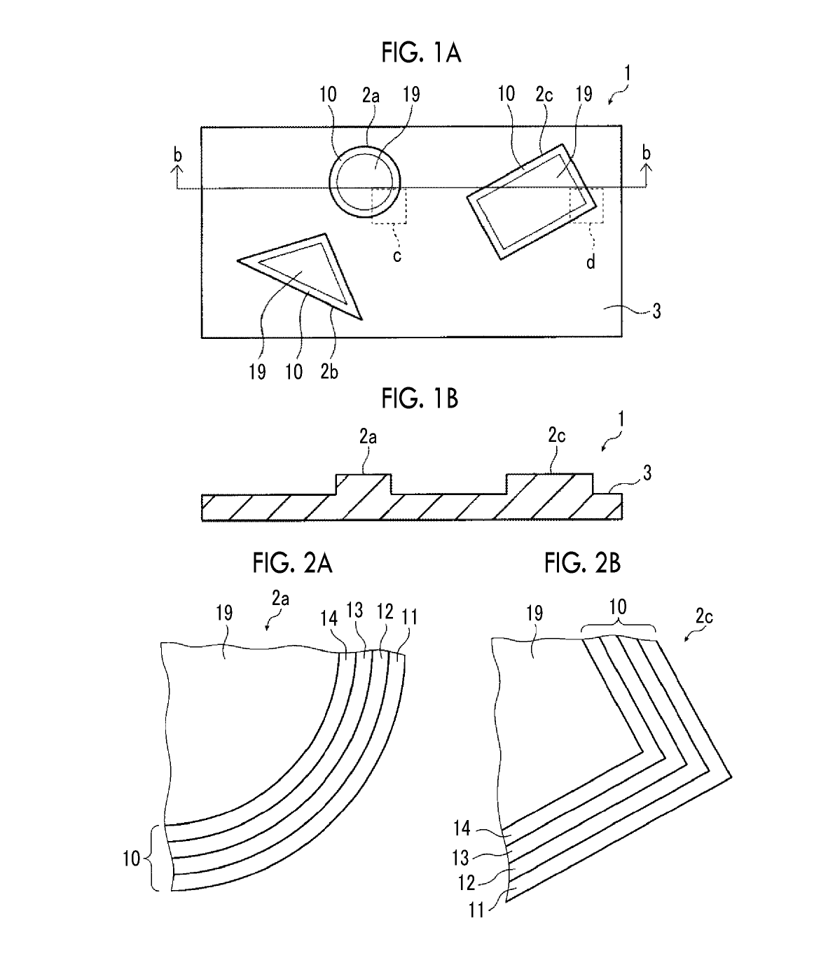

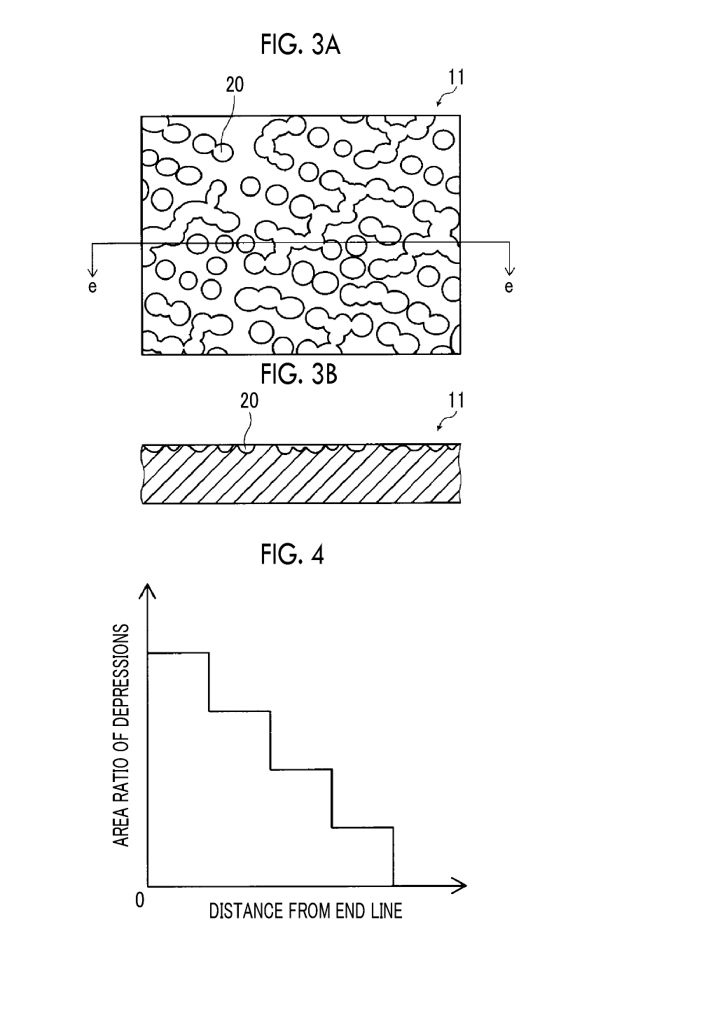

FIG. 1A is a front view schematically showing an example of the flexo printing plate according to the present invention, and FIG. 1B is a sectional view taken along the line b-b of FIG. 1A. FIG. 2A is a partially enlarged view showing a portion (c portion) of an image portion 2a of the flexo printing plate shown in FIG. 1A through enlargement, and FIG. 2B is a partially enlarged view showing a portion (d portion) of an image portion 2c of the flexo printing plate shown in FIG. 1A through enlargement. Furthermore, FIG. 3A is a front view schematically showing a portion of an end region of the flexo printing plate shown in FIG. 1A through enlargement, and FIG. 3B is a sectional view taken along the line e-e of FIG. 3A.

As shown in FIGS. 1A and 1B, a flexo printing plate 1 as an example of the flexo printing plate according to the present invention has 3 image portions 2a to 2c which are projections for printing and a non-image portion 3 which is a region where an image is not formed at the time of printing.

Each of the image portions 2a, 2b, and 2c has an end region 10 within a region having a predetermined width measured from the edge. In the end region 10, a plurality of depressions 20 having a depth of 2 μm to 9 μm as shown in FIGS. 3A and 3B is formed as predetermined patterns.

The formation pattern of the depressions 20 in the end region 10 is a pattern in which an area ratio of the depressions 20 decreases as the depressions become further away from the edge, that is, a gradation pattern.

FIG. 4 shows a graph schematically showing the relationship between the area ratio of the depressions 20 and a distance from the edge.

As shown in FIG. 4, the formation pattern of the depressions 20 has a constitution in which the area ratio changes in stages as the depressions become further away from the edge.

Herein, the area ratio of the depressions 20 is the ratio of an opening area of the depressions 20 per unit area measured in a measurement region having a size of a×100b on the premise that the dimension of an opening portion of each of the depressions 20 is represented by length a×width b. The dimension in the opening portion of each of the depressions in the vertical direction is the length in a direction orthogonal to the edge, and the dimension in the horizontal direction is the length in a direction parallel to the edge.

Specifically, as shown in FIGS. 2A and 2B, the end region 10 is constituted with 4 partial regions 11 to 14 having the approximately same width in the direction orthogonal to the edge. In each of the partial regions, the depressions 20 are formed at a predetermined area ratio.

Herein, the partial region refers to a region in which the area ratio is and includes a region in which the area ratio is within a range of ±0.3%.

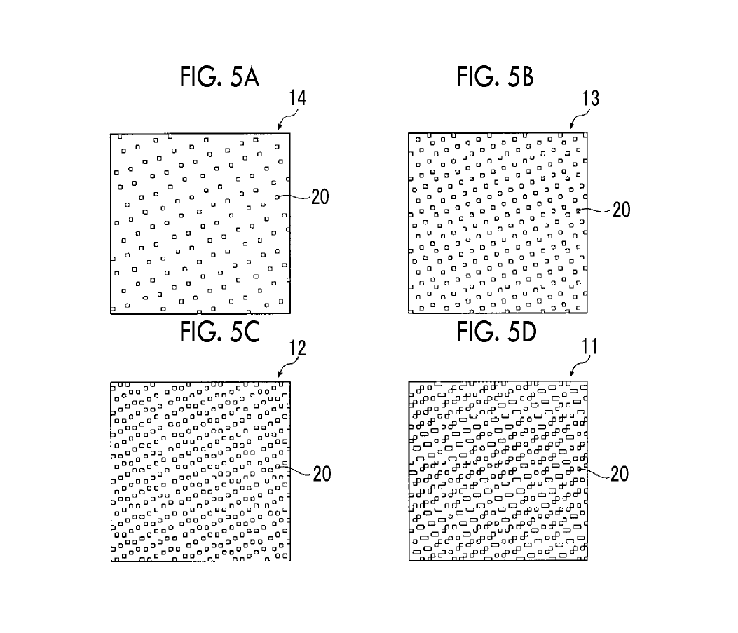

FIGS. 5A to 5D are views schematically showing the ratio at which the depressions are formed in each of the partial regions.

FIG. 5A is a partially enlarged view showing the surface of the first partial region 11 through enlargement; FIG. 5B is a partially enlarge view showing the surface of the second partial region 12 through enlargement; FIG. 5C is a partially enlarged view showing the surface of the third partial region 13 through enlargement; and FIG. 5D is a partially enlarged view showing the surface of the fourth partial region 14 through enlargement.

As shown in FIGS. 5A to 5D, the depressions 20 are formed such that the area ratio thereof increases toward the edge, that is, increases in order of the fourth partial region 14, the third partial region 13, and the second partial region 12 and becomes maximum in the first partial region 11 closest to the edge side.

In the examples illustrated in the drawings, the area ratio of the depressions 20 is 20% in the first partial region 11, 15% in the second partial region 12, 10% in the third partial region 13, and 5% in the fourth partial region 14.

As described above, during flexo printing performed using a flexo printing plate, transfer failure of ink occurs in the rear end portion of an image portion in the printing direction, and this leads to a problem of the occurrence of voids in the formed image.

According to the investigation conducted by the inventors of the present invention, it was found that if the pressure applied to the flexo printing plate is not uniform at the time of printing, inking failure occurs in the form of stripes in the rear end portion of an image portion, and thus voids (hereinafter, referred to as “rear end voids” as well) occur.

As a solution to the problem, the present inventors found that for uniformizing the pressure applied to the flexo printing plate, it is effective to provide depressions in the image portion.

The present inventors found that in a case where the depressions are provided simply in the rear end portion of the image portion, a problem occurs in that the discontinuity of the boundary between a region where the patterns of the depressions are formed and a solid region becomes visible.

They also found that in a case where the patterns of the depressions are uniformly formed in the entirety of the image portion, a problem of decrease in the solid density.

Therefore, in the flexo printing plate according to the present invention, in an end region having a predetermined width measured from the edge in the image portion, depressions having a depth of 2 μm to 9 μm are formed as patterns such that the area ratio of the depressions in the end region becomes maximum at the edge side and minimum at the central side of the image portion. By performing flexo printing by using such a flexo printing plate, it is possible to inhibit the occurrence of rear end voids, to prevent the decrease in the solid density, and to prevent the discontinuity of density from becoming visible in the boundary between the region (end region) where the depressions are formed and the solid region.

That is, by providing the depressions having a depth of 2 μm to 9 μm in the end region of the flexo printing plate, it is possible to inhibit the occurrence of the rear end voids while preventing the decrease in the solid density at the time of printing. Furthermore, by forming the patterns of the depressions according to the formation pattern in which the area ratio of the depressions becomes maximum at the edge side and minimum at the central side (solid region side), it is possible to prevent the discontinuity of the boundary between the region where the patterns of the depressions are formed and the solid region from becoming visible.

Herein, if the depth of the depressions is less than 2 μm, the nonuniformity of the pressure applied to the flexo printing plate cannot be sufficiently mitigated. Consequently, inking failure occurs in the form of stripes in the rear end portion, and hence the rear end voids occur. Furthermore, if the depth of the depression is greater than 9 μm, ink is insufficiently transferred, and hence the density of printed image decreases.

Accordingly, the depth of the depressions is preferably within a range of 2 μm to 9 μm, and more preferably within a range of 5 μm to 8 μm.

The shape of the opening portion of each of the depressions is not particularly limited, and the opening portion may take various shapes such as a circular shape, a square shape, a rectangular shape, and a polygonal shape. In a case where the area ratio of the depressions is great, the depressions may be formed such that the depressions adjacent to each other overlap with each other and have a large opening portion.

The opening area of each of the depressions is preferably within a range of 25 μm² to 2,500 μm², and more preferably within a range of 100 μm² to 1,000 μm².

If the opening area of each depression is less than 25 μm², the nonuniformity of the pressure applied to the flexo printing plate may not be able to be sufficiently mitigated, and the occurrence of the rear end voids may not be able to be inhibited. In contrast, if the opening area of each depression is greater than 2,500 μm², ink may be insufficiently transferred, and the density of the printed image may decrease.

The sectional shape of each depression, that is, the shape of the section in a direction orthogonal to the surface of the image portion is not particularly limited. The section may take a wavy shape as shown in FIG. 3B or take various shapes such as an approximately rectangular shape, an approximately trapezoidal shape, and an approximately triangular shape. From the viewpoint of strength, the lateral surface of each depression preferably has a slope.

The width of the end region is not particularly limited and should be set according to the range in which the rear end voids occur. The width of the region in which the rear end voids occur varies with the printing rate, the diameter of a drum onto which a printing plate is loaded (that is, the radius of curvature of a printing plate at the time of printing), the type of ink, the material of the printing target, temperature, humidity, and the like. Therefore, according to these conditions, the width of the end region should be set. Under the generally used printing conditions, the width, measured from the edge, of the region in which the rear end voids occurs is within a range of 0.1 μm to 600 μm, and accordingly, the width of the end region measured from the edge should be within a range of 0.1 μm to 600 μm. The width of the end region is more preferably 0.5 μm to 550 μm, and particularly preferably 1 μm to 500 μm.

In the example illustrated in the drawing, the formation pattern of the depressions in the end region has a constitution in which the area ratio thereof changes in stages as the depressions become further away from the edge. However, the present invention is not limited thereto and may adopt a constitution in which the area ratio continuously changes.

Furthermore, in the example illustrated in the drawing, the end region has a constitution in which the end region has 4 partial regions, that is, a constitution in which the area ratio changes in 4 stages (the change of the area ratio is represented by 4 gradations). However, the present invention is not limited thereto and may be adopt a constitution in which the area ratio changes in 2 stages, 3 stages, or 5 or more stages.

In addition, the present invention is not limited to the constitution in which the area ratio of the depressions decreases as the depressions become further away from the edge, as long as the area ratio of the depressions becomes maximum at the side closest to the edge and minimum at the central side of the image portion.

In the example illustrated in the drawing, the partial regions in the end region have the same width. However, the present invention is not limited thereto, and the partial regions may have different widths. Herein, the width of each of the partial regions is preferably 50 μm to 150 μm.

The area ratio of the depressions in the partial region closest to the edge side is preferably 11% to 54%, and more preferably 15% to 30%.

By setting the area ratio of the depressions in the partial region closest to the edge side to be equal to or greater than 11%, the rear end voids can be more suitably inhibited. If the area ratio of the depressions in the partial region closest to the edge side is greater than 54%, the density of the printed image may decrease.

A difference in the area ratio of depressions between partial regions adjacent to each other is preferably equal to or less than 9%, and more preferably equal to or less than 5%. In a case where the difference in the area ratio of the depressions between partial regions adjacent to each other is greater than 9%, that is, in a case where the change in gradation is sharp, the difference of the amount of ink transferred may leads to inking unevenness which will become visible.

The difference in the area ratio of depressions between the partial region at the solid region side (central side of the image portion) and the solid region is preferably equal to or less than 9%, and more preferably equal to or less than 5%. If the difference in the area ratio is within the above range, it is possible to more suitably prevent the discontinuity of density from becoming visible at the boundary between the region (end region) where the depressions are formed and the solid region.

In the example illustrated in the drawing, a constitution is adopted in which the number of the depressions is varied between the partial regions so as to adjust the area ratio of the depressions of each of the partial regions. However, the present invention is not limited thereto, and a constitution may be adopted in which the size (opening area) of the depressions is varied between the partial regions so as to adjust the area ratio of the depressions of each of the partial regions.

Furthermore, uniform depressions may be provided in the entirety of the solid region of the image portion. Herein, in a case where the depressions are formed in the entirety of the image portion as described above, the solid density may decrease. Accordingly, in a case where the depressions are formed in the solid region, in order to suppress the decrease in the solid density, it is preferable to set the area ratio of the depressions to be equal to or less than 9%. In addition, in a case where the depressions are provided in the solid region, it is preferable to set the area ratio of the depressions to be equal to or less than the area ratio of the depressions of the partial region of the end region that is at the solid region side.

In the example illustrated in the drawing, a constitution is adopted in which the printing plate has 3 image portions. However, the present invention is not limited thereto, and a constitution may be adopted in which the printing plate has 1 or 2 image portions or 4 or more image portions.

Furthermore, in the example shown in the drawing, a constitution is adopted in which each of the 3 image portions has an end region where the depressions are formed according to a predetermined pattern. However, the present invention is not limited thereto, and a constitution may be adopted in which at least 1 image portion has an end region where the depressions are formed.

[Method for Manufacturing Flexo Printing Plate]

Next, a method for manufacturing a flexo printing plate will be specifically described.

The method for manufacturing a flexo printing plate is a method in which a non-image portion is formed by laser-engraving a cured layer (relief forming layer) of a flexo printing plate precursor; an image portion having a projection shape is formed; and patterns of depressions are formed in an end region of the image portion by laser engraving.

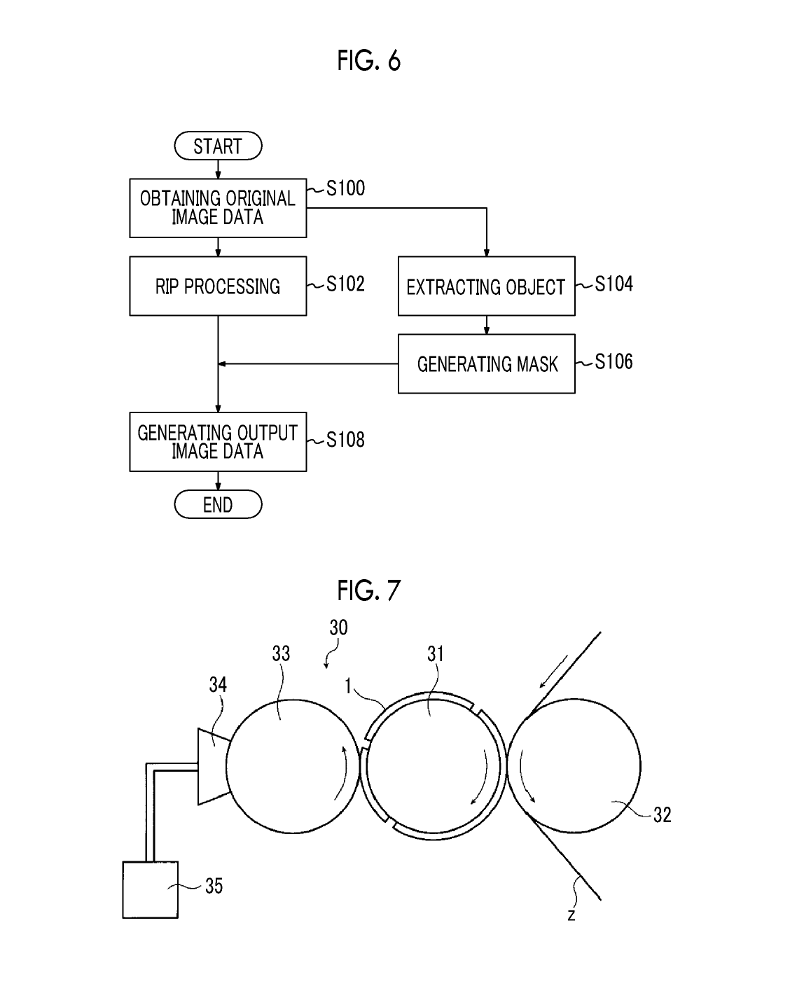

FIG. 6 is a flow chart showing an example of a method for generating image data for laser engraving in the method for manufacturing a flexo printing plate of the present invention.

As shown in FIG. 6, first, original image data of a printing plate to be prepared is obtained (S100).

Then, in order to convert the original image data into data for performing laser engraving, processing using Raster Image Processor (RIP) is performed (S102).

Meanwhile, by rasterizing the original image data, a plurality of partial regions having a predetermined width measured from the periphery (edge) of each image portion is extracted (S104).

On each of the extracted partial regions, each template (see FIGS. 5A to 5D) having depression patterns with a predetermined area ratio is superimposed, thereby generating a mask (S106). At this time, the template is selected such that the area ratio of the depressions increases toward the region at the peripheral side.

Furthermore, the image data having undergone the RIP processing is multiplied by the generated mask, thereby generating output image data.

In this way, by adding the depression patterns to the end region of the image portion of the original image data, the output image data is generated, and laser engraving is performed using the output image data, thereby preparing a flexo printing plate.

Herein, the laser engraving method is basically the same as the laser engraving method used in the method for manufacturing a flexo printing plate of the related art.

As the laser engraving method, for example, it is possible to use a method in which a sheet-like printing plate precursor for laser engraving is wound around the outer peripheral surface of a cylindrical drum; the drum is rotated; a laser beam corresponding to the aforementioned output image data is emitted to the printing plate precursor F from an exposure head; and the exposure head is caused to perform scanning at a predetermined pitch in a sub-scanning direction orthogonal to a main scanning direction such that a two-dimensional image is engraved (recorded) at a high speed on the surface of the printing plate precursor.

The type of the laser used in the laser engraving is not particularly limited, but an infrared laser is preferably used. By the irradiation of the infrared laser, molecules in the cured layer vibrate, and hence heat is generated. If a high-power laser such as a carbon dioxide laser or a YAG laser is used as the infrared laser, a large amount of heat is generated in the portion irradiated with the laser, and the molecules in the cured layer is cleaved or ionized. As a result, the cured layer undergoes selective removal of the molecules, that is, engraving. The advantage of the laser engraving is that it enables three-dimensional control of structures because the engraving depth can be arbitrarily set. For example, in a portion on which minute dots are printed, by shallowly engraving the cured layer or by engraving the cured layer with forming shoulders, it is possible to prevent the relief from being inverted due to the printing pressure. Furthermore, in a groove portion on which fine outline letters are printed, by deeply engraving the cured layer, it is possible to prevent the ink from easily filling the grooves and to inhibit the outline letters from being crushed.

Particularly, in a case where engraving is performed using an infrared laser corresponding to the absorption wavelength of a photothermal conversion agent, the cured layer can be selectively removed with higher sensitivity, and hence a relief layer having a sharp image is obtained.

As the infrared laser, in view of productivity, costs, and the like, a carbon dioxide laser (CO₂ laser) or a semiconductor laser is preferable, and a semiconductor infrared laser with fiber (FC-LD) is particularly preferable. Generally, compared to the CO₂ laser, the semiconductor laser has higher laser oscillation efficiency, is less expensive, and can be further miniaturized. Furthermore, it is easy to make an array of the semiconductor lasers because of the small size thereof. In addition, by treating the fiber, the beam shape can be controlled.

The wavelength of the semiconductor laser is preferably 700 nm to 1,300 nm, more preferably 800 to 1,200 nm, even more preferably 860 to 1,200 nm, and particularly preferably 900 nm to 1,100 nm.

If optical fiber is additionally mounted on the semiconductor laser with fiber, the laser can efficiently emit laser beams, and accordingly, such a laser is effective for the step S100 of the laser engraving in the present invention. Furthermore, by treating the fiber, the beam shape can be controlled. For example, it is possible to make the beam profile have a top-hat shape, and in this way, energy can be stably applied to the surface of the plate. Details of the semiconductor laser are described in “Laser Handbook, 2^{nd} Edition” edited by Laser Society of Japan, and in “Practical Laser Technology” written and edited by Institute of Electronics and Communication Engineers of Japan.

In addition, a plate-making apparatus including the semiconductor laser with fiber specifically described in JP2009-172658A and JP2009-214334A can be suitably used in the manufacturing method of the present invention.

[Flexo Printing Plate Precursor]

The flexo printing plate precursor used in the present invention is not particularly limited as long as it is a known resin plate or rubber plate for flexo printing. Furthermore, the printing plate precursor may have a sheet shape or a cylindrical shape.

It is preferable that the printing plate precursor has, as a cured layer, a layer of a curable resin composition that is cured.

The layer of a curable resin composition in the printing pate precursor is preferably a layer having a cross-linked structure, and more preferably a layer cross-linked by heat and/or light.

The method for forming the printing plate precursor is not particularly limited. Examples of the method preferably include a method in which a curable resin composition is prepared; a solvent is removed from the curable resin composition if necessary; and then the composition is melt-extruded onto a substrate, and a method in which a curable resin composition is cast onto a substrate; and a layer is formed by removing at least a portion of the solvent in the curable resin composition. Among, these, the method is more preferable in which a curable resin composition is cast onto a substrate; and a layer is formed by removing at least a portion of the solvent in the curable resin composition. In addition, after the layer of the curable resin composition is formed as above, it is preferable to cross-link the layer of a curable resin composition by applying heat and/or light thereto.

The curable resin composition can be prepared by, for example, dissolving a cross-linking agent, a binder polymer, and optional components such as a photothermal conversion agent, fragrance, and a plasticizer in an appropriate solvent. Most of the solvent components need to be removed at the stage of manufacturing the printing plate precursor. Therefore, it is preferable to use, as the solvent, an easily volatilizing low-molecular weight alcohol (for example, methanol, ethanol, n-propanol, isopropanol, or propylene glycol monomethyl ether) and to reduce the total amount of the added solvent as much as possible by adjusting the temperature.

The thickness of the cured resin layer in the printing plate precursor is preferably equal to or greater than 0.05 mm and equal to or less than 20 mm, more preferably equal to or greater than 0.5 mm and equal to or less than 10 mm, even more preferably equal to or greater than 0.5 mm and equal to or less than 7 mm, and particularly preferably equal to or greater than 0.5 mm and equal to or less than 3 mm.

The thickness of the printing plate precursor is preferably equal to or greater than 0.1 mm and equal to or less than 20 mm, more preferably equal to or greater than 0.5 mm and equal to or less than 10 mm, even more preferably equal to or greater than 0.5 mm and equal to or less than 7 mm, and particularly preferably equal to or greater than 0.5 mm and equal to or less than 3 mm.

The printing plate precursor may have a layer other than the cured resin layer, and examples of the layer include known layers such as a support layer (simply referred to as a “support” as well), an adhesive layer, a protective layer, a slip coating layer, and a cushion layer that the printing plate precursor may have.

The material used in the support is not particularly limited. However, materials having high dimensional stability are preferably used, and examples thereof include a metal such as steel, stainless steel, or aluminum; a plastic resin such as polyester (for example, polyethylene terephthalate (PET), polybutylene terephthalate (PBT), or polyacrylonitrile (PAN)) or polyvinyl chloride; synthetic rubber such as styrene-butadiene rubber; and a plastic resin (such as an epoxy resin or a phenol resin) reinforced with glass fiber. As the support, a PET film or a steel substrate is preferably used. Among these, the support is preferably a transparent support and more preferably a PET film.

The adhesive layer can be formed of a known adhesive.

The adhesive is preferably a photocurable adhesive, more preferably a photocurable adhesive containing a hydroxyl group-containing (meth)acrylate compound, a hydroxyl group-free (meth)acrylate compound, and a photopolymerization initiator, and even more preferably a photocurable adhesive solely composed of a hydroxyl group-containing (meth)acrylate compound, a hydroxyl group-free(meth)acrylate compound, and a photopolymerization initiator. As the photocurable adhesive, those described in JP2011-173295A can be suitably used.

As the material (adhesive) usable in the adhesive layer, for example, those described in “Handbook of Adhesives, 2^{nd} edition (1977)” edited by I. Skeist can be used.

The material of the protective layer is not particularly limited, and materials known as protective films of printing plates, for example, a polyester-based film such as polyethylene terephthalate (PET) and polyolefin-based film such as polyethylene (PE) or polypropylene (PP) can be used. In addition, the surface of the film may be planar or may be matted.

The thickness of the protective layer is preferably 25 μm to 500 μm, and more preferably 50 μm to 200 μm.

The material of the cushion layer is not particularly limited, and the cushion layer should be formed of a known material. Examples thereof include an elastic foamed resin such as sponge.

It is preferable that the material used in the slip coating layer contains, as a main component, a resin such as polyvinyl alcohol, polyvinyl acetate, partially saponified polyvinyl alcohol, hydroxyalkyl cellulose, alkyl cellulose, or a polyamide resin that can be dissolved or dispersed in water and exhibits weak adhesiveness.

Hereinafter, the constituents of the resin composition will be described.

(Cross-Linking Agent)

For forming a cross-linked structure in the relief forming layer (recording layer), it is preferable that the resin composition contains a cross-linking agent.

Furthermore, it is preferable that the recording layer has a cross-linked structure.

The cross-linking agent usable in the present invention can be used without particular limitation as long as it enables the recording layer to be cured by turning into a polymer through a chemical reaction caused by light or heat. Particularly, a polymerizable compound having an ethylenically unsaturated group (hereinafter, referred to as a “polymerizable compound” as well), a reactive silane compound having a reactive silyl group such as an alkoxysilyl group or a halogenated silyl group, a reactive titanium compound, a reactive aluminum compound, and the like are preferably used, and a reactive silane compound is more preferably used. These compounds may form a cross-linked structure in the recording layer by reacting with the aforementioned binder or by reacting with each other. Alternatively, these compounds may form a cross-linked structure by reacting with the binder and reacting with each other.

The polymerizable compound that can be used herein can be randomly selected from the compounds having at least one ethylenically unsaturated group, preferably having 2 or more ethylenically unsaturated groups, and even more preferably having 2 to 6 ethylenically unsaturated groups.

It is preferable that the resin composition contains a compound (hereinafter, referred to as a “compound (I)” as well) having a group represented by the following Formula (I).

—M(R¹)(R²)ₙ (i)

(In Formula (I), R¹ represents OR³ or a halogen atom; M represents Si, Ti, or Al; when M is Si, n is 2; when M is Ti, n is 2; when M is Al, n is 1; each of n—R² independently represents a hydrocarbon group, OR³, or a halogen atom; and R³ represents a hydrogen atom or a hydrocarbon group.)

In Formula (I), M represents Si, Ti, or Al. Among these, M is preferably Si or Ti, and more preferably Si.

In Formula (I), R¹ represents OR³ or a halogen atom, and R³ represents a hydrogen atom or a hydrocarbon group. Examples of the hydrocarbon group include an alkyl group having 1 to 30 carbon atoms, an aryl group having 6 to 30 carbon atoms, an alkenyl group having 2 to 30 carbon atoms, an aralkyl group having 7 to 37 carbon atoms, and the like. Among these, R³ is preferably a hydrogen atom, an alkyl group having 1 to 12 carbon atoms, or an aryl group having 6 to 20 carbon atoms, more preferably a hydrogen atom, an alkyl group having 1 to 5 carbon atoms, or an aryl group having 6 to 10 carbon atoms, and particularly preferably a methyl group or an ethyl group. That is, R¹ is particularly preferably a methoxy group or an ethoxy group.

In Formula (I), R² represents a hydrocarbon group, OR^{4,} or a halogen atom. Examples of the hydrocarbon group include an alkyl group having 1 to 30 carbon atoms, an aryl group having 6 to 30 carbon atoms, an alkenyl group having 2 to 30 carbon atoms, an aralkyl group having 7 to 37 carbon atoms, and the like. R⁴ has the same definition as R³ described above, and the preferred range thereof is also the same.

R² is preferably OR⁴ or a halogen atom, and more preferably OR^{4.}

When M is Si, n is 2. When M is Si, a plurality of R²s may be the same as or different from each other and is not particularly limited.

When M is Ti, n is 2. When M is Ti, a plurality of R²s may be the same as or different from each other and is not particularly limited.

When M is Al, n represents 1.

The compound (I) may be either a compound which introduces a group represented by Formula (I) into a polymer by reacting with the polymer, or a compound which has a group represented by Formula (I) before reaction and introduces the group represented by Formula (I) into a polymer.

In the present invention, as the compound (I), silica particles, titanium oxide particles, aluminum oxide particles, and the like can be used. These particles can introduce the group represented by Formula (I) into a polymer by reacting with the polymer which will be described later. For example, through the reaction between silica particles and the polymer which will be described later, —SiOH is introduced into the polymer.

Examples of titanium coupling agents include PLENACT manufactured by Ajinomoto Fine-Techno Co.,Inc., titanium tetraisopropoxide manufactured by Matsumoto Fine Chemical Co., Ltd., and titanium-i-propoxybis(acetylacetonate)titanium manufactured by NIPPON SODA CO., LTD. Examples of aluminate-based coupling agents include acetoalkoxyaluminum diisopropylate.

In the present invention, one kind of the compound (I) may be used singly, or two or more kinds thereof may be used concurrently.

In the present invention, the amount of the compound (I) contained in the resin composition, expressed in terms of solid contents, is preferably 0.1% by weight to 80% by weight, more preferably 1% by weight to 40% by weight, and even more preferably 5% by weight to 30% by weight.

The polymerizable compound can be randomly selected from compounds having at least 1 ethylenically unsaturated group, preferably having 2 or more ethylenically unsaturated groups, and more preferably having 2 to 6 ethylenically unsaturated groups.

In the present invention, for the purpose of forming the cross-linked structure and from the viewpoint of film properties such as flexibility and brittleness, a compound (monofunctional polymerizable compound or monofunctional monomer) having only one ethylenically unsaturated group may be used.

Hereinafter, the compound (monofunctional monomer) having 1 ethylenically unsaturated group in the molecule and the compound having 2 or more ethylenically unsaturated groups in the molecule (polyfunctional monomer) that are used as the polymerizable compound will be described.

Because the recording layer needs to have a cross-linked structure in the film, a polyfunctional monomer is preferably used. The molecular weight of the polyfunctional monomer is preferably 200 to 2,000.

Examples of the monofunctional monomer and the polyfunctional monomer include esters of unsaturated carboxylic acid (for example, acrylic acid, methacrylic acid, itaconic acid, crotonic acid, isocrotonic acid, or maleic acid) and a polyol compound; amides of unsaturated carboxylic acid and a polyamine compound; and the like.

In the present invention, from the viewpoint of improving the engraving sensitivity, it is preferable to use a compound having a sulfur atom in the molecule as the polymerizable compound.

As the polymerizable compound having a sulfur atom in the molecule, from the viewpoint of improving the engraving sensitivity, it is particularly preferable to use a polymerizable compound (hereinafter, referred to as a “sulfur-containing polyfunctional monomer” as appropriate) having 2 or more ethylenically unsaturated bonds and having a carbon-sulfur bond at a site where two out of the ethylenically unsaturated bonds are linked to each other.

Examples of functional groups having the carbon-sulfur bond in the sulfur-containing polyfunctional monomer in the present invention include functional groups containing sulfide, disulfide, sulfoxide, sulfonyl, sulfonamide, thiocarbonyl, thiocarboxylic acid, dithiocarboxylic acid, sulfamic acid, thioamide, thiocarbamate, dithiocarbamate, or thiourea.

A linking group containing the carbon-sulfur bond linking 2 ethylenically unsaturated bonds in the sulfur-containing polyfunctional monomer is preferably at least one unit selected from the group consisting of —C—S , —C—S—S, —NH(C═S)O—, —NH(C═O)S—, —NH(C═S)S—, and —C—SO₂—.

The number of sulfur atoms contained in the molecule of the sulfur-containing polyfunctional monomer is not particularly limited as long as it is equal to or greater than 1, and can be appropriately selected according to the purpose. However, from the viewpoint of the balance between the engraving sensitivity and the solubility in a coating solvent, the number of sulfur atoms is preferably 1 to 10, more preferably 1 to 5, and even more preferably 1 or 2.

The number of ethylenically unsaturated groups contained in the molecule is not particularly limited as long as it is equal to or greater than 2, and can be appropriately selected according to the purpose. However, from the viewpoint of the flexibility of the cross-linked film, the number of the ethylenically unsaturated groups is preferably 2 to 10, more preferably 2 to 6, and even more preferably 2 to 4.

From the viewpoint of the flexibility of the film to be formed, the molecular weight of the sulfur-containing polyfunctional monomer in the present invention is preferably 120 to 3,000, and more preferably 120 to 1,500.

In the present invention, the sulfur-containing polyfunctional monomer may be used singly or used in the form of a mixture with the polyfunctional polymerizable compound or the monofunctional polymerizable compound not having a sulfur atom in the molecule.

From the viewpoint of the engraving sensitivity, an embodiment is preferable in which the sulfur-containing polyfunctional monomer is used singly or used in the form of a mixture with the monofunctional monomer, and an embodiment is more preferable in which the sulfur-containing polyfunctional monomer is used in the form of a mixture with the monofunctional monomer.

By using the polymerizable compound including the sulfur-containing polyfunctional monomer in the recording layer, the film properties, for example, brittleness, flexibility, and the like can be adjusted.

From the viewpoint of the flexibility or brittleness of the cross-linked film, the total content of the polymerizable compound including the sulfur-containing polyfunctional monomer in the resin composition is preferably within a range of 10% by weight to 60% by weight, and more preferably within a range of 15% by weight to 45% by weight, with respect to non-volatile components.

In a case where the sulfur-containing polyfunctional monomer is used concurrently with other polymerizable compounds, the amount of the sulfur-containing polyfunctional monomer in all of the polymerizable compounds is preferably equal to or greater than 5% by weight, and more preferably equal to or greater than 10% by weight.

(Binder Polymer)

It is preferable that the resin composition contains a binder polymer (hereinafter, referred to as a “binder” as well).

The binder is a polymer component contained in the resin composition and appropriately selected from general polymer compounds. One kind of the binder can be used singly, or two or more kinds thereof can be used concurrently. Particularly, at the time of using the resin composition for laser engraving in the printing plate precursor, the binder needs to be selected in consideration of various performances such as laser engraving properties, ink applicability, and engraving scum dispersibility.

As the binder, it is possible to use a polymer selected from a polystyrene resin, a polyester resin, a polyamide resin, a polyurea resin, a polyamide imide resin, a polyurethane resin, a polysulfone resin, a polyether sulfone resin, a polyimide resin, a polycarbonate resin, a hydrophilic polymer containing a hydroxyethylene unit, an acryl resin, an acetal resin, an epoxy resin, rubber, a thermoplastic elastomer, and the like.

For example, from the viewpoint of the laser engraving sensitivity, a polymer having a partial structure thermally decomposed by light exposure or heating is preferable. Examples of the polymer preferably include those described in paragraph “0038” of JP2008-163081A. Furthermore, for example, in a case where the goal is the formation of a flexible film, a soft resin or a thermoplastic elastomer is selected, and details thereof are described in paragraphs “0039” and “0040” of JP2008-163081A. In addition, from the viewpoint of the ease of preparation of the resin composition and the improvement of resistance of the obtained printing plate against oil ink, it is preferable to use a hydrophilic polymer or an alcohol-philic polymer. As the hydrophilic polymer, those specifically described in paragraph “0041” of JP2008-163081A can be used.

Moreover, in a case where the binder is used for the purpose of improving strength by being cured through heating or light exposure, a polymer having an unsaturated carbon-carbon bond in the molecule is preferably used.

Examples of such a polymer include polymers having an unsaturated carbon-carbon bond on the main chain, such as polystyrene-polybutadiene (SB), polystyrene-polybutadiene-polystyrene (SBS), polystyrene-polyisoprene-polystyrene (SIS), and polystyrene-polyethylene/polybutyrene-polystyrene (SEBS).

A polymer having an unsaturated carbon-carbon bond on the side chain is obtained by introducing an unsaturated carbon-carbon bond such as an allyl group, an acryloyl group, a methacryloyl group, a styryl group, or a vinyl ether group into the skeleton of a polymer. As the method for introducing the unsaturated carbon-carbon bond into the side chain of the polymer, it is possible to adopt known methods such as (1) a method of copolymerizing a structural unit, which has a polymerizable precursor obtained by binding a protective group to a polymerizable group, with a polymer and dissociating the protective group so as to obtain a polymerizable group, and (2) a method of preparing a polymer compound having a plurality of reactive groups such as hydroxyl groups, amino groups, epoxy groups, or carboxyl groups and causing a polymerization reaction of the prepared polymer compound and a compound, which has a group reacting with the above reactive groups and an unsaturated carbon-carbon bond, such that the unsaturated carbon-carbon bond is introduced into the polymer compound. According to these methods, the amount of the unsaturated bond and the polymerizable group introduced into the polymer compound can be controlled.

As the binder, a polymer (hereinafter, referred to as a “specific polymer” as well) having a hydroxyl group (—OH) is particularly preferable. The skeleton of the specific polymer is not particularly limited but is preferably an acryl resin, an epoxy resin, a hydrophilic polymer having a hydroxyethylene unit, a polyvinyl acetal resin, a polyester resin, or a polyurethane resin.

As acryl monomers used for the synthesis of the acryl resin having a hydroxyl group, for example, (meth)acrylic acid esters, crotonic acid esters, and (meth)acrylamides having a hydroxyl group in the molecule are preferable. Specific examples of such monomers include 2-hydroxyethyl (meth)acrylate, 2-hydroxypropyl (meth)acrylate, 4-hydroxybutyl (meth)acrylate, and the like. Copolymers obtained by polymerizing these monomers with a known (meth)acryl-based monomer or vinyl-based monomer can be preferably used.

As the specific monomer, an epoxy resin having a hydroxy group on the side chain can also be used. Specifically, for example, an epoxy resin obtained by polymerizing an adduct of bisphenol A and epichlorohydrin with a raw material monomer is preferable.

As the polyester resin, a polyester resin composed of a hydroxylcarboxylic acid unit such as polylactic acid can be preferably used. Specifically, such a polyester resin is preferably selected from the group consisting of polyhydroxyalkanoate (PHA), a lactic acid-based polymer, polyglycolic acid (PGA), polycaprolactone (PCL), poly(butylene succinate), and derivatives or mixtures of these.

The specific polymer is preferably a polymer which has an atom and/or a group being able to react with the compound (I) described above, and more preferably a binder polymer which has an atom and/or a group being able to react with the compound (I) described above and is insoluble in water and soluble in an alcohol having 1 to 4 carbon atoms.

The atom and/or the group being able to react with the compound (I) described above is not particularly limited, and examples thereof include an ethylenically unsaturated bond, an epoxy group, an amino group, a (meth)acryloyl group, a mercapto group, and a hydroxy group. Among these, a hydroxy group is preferable.

As the specific polymer in the present vention, for example, polyvinyl butyral (PVB), an acryl resin having a hydroxyl group on the side chain, an epoxy resin having a hydroxyl group on the side chain, and the like are preferable, because these polymers exhibit both the aqueous ink suitability and UV ink suitability and have high engraving sensitivity and excellent coating properties.

Furthermore, as described above, from the viewpoint of the solubility in an alkaline aqueous solution, as the binder, a material generating a carboxyl group or a hydroxyl group by an oxidation reaction is preferably used.

Examples of such a binder include polyvinyl butyral (PVB) and polyvinyl alcohol (PVA). As the binder, a material having C═C (double bond) on the main chain, for example, polyisoprene, polybutadiene (PB), and the like are more preferable.

In a case where the specific polymer usable in the present invention is combined with a photothermal conversion agent, which is preferred as a component concurrently used with the resin composition for laser engraving constituting the recording layer in the present invention and can absorb light, which will be described later, having a wavelength of 700 m to 1,300 nm, the glass transition temperature (Tg) of the polymer becomes equal to or higher than 20° C., and hence the engraving sensitivity is improved. Therefore, the specific polymer is particularly preferable. Hereinafter, the polymer having such a glass transition temperature will be referred to as a non-elastomer. That is, generally, an elastomer is academically defined as a polymer having a glass transition temperature of equal to or lower than room temperature (see “Scientific Encyclopedia, 2^{nd} Edition”, p. 154, written and edited by Foundation for Advancement of International Science, published by MARUZEN PUBLISHING CO., LTD.). Accordingly, the non-elastomer refers to a polymer having a glass transition temperature of higher than room temperature. The upper limit of the glass transition temperature of the specific polymer is not particularly limited. However, from the viewpoint of handleability, the upper limit of the glass transition temperature is preferably equal to or lower than 200° C., and more preferably equal to or higher than 25° C. and equal to or lower than 120° C.

In a case where a polymer having a glass transition temperature of equal to or higher than room temperature (20° C.) is used, the specific polymer is in a glass state at room temperature. However, because of being in a glass state, thermal molecular motion thereof is greatly suppressed compared to the rubber state. During laser engraving, at the time of laser irradiation, in addition to the heat supplied from the infrared laser, the heat generated by the function of the photothermal conversion agent which is concurrently used as desired is transferred to the surrounding specific polymer, and the polymer is thermally decomposed and burned off. As a result, the recording layer is engraved, and depressions are formed.

Presumably, in a case where the specific polymer is used, if the photothermal conversion agent is present in a state where the thermal molecular motion of the specific polymer is suppressed, heat transfer to the specific polymer and thermal decomposition may effectively occur, and due to the effect, the engraving sensitivity may further increase.

Specific examples of the binder preferably used in the present invention are as below.

(1) Polyvinyl acetal and derivative thereof

Polyvinyl acetal is a compound obtained by making polyvinyl alcohol (obtained by saponifying polyvinyl acetate) into cyclic acetal. Furthermore, a polyvinyl acetal derivative is a substance obtained by modifying the polyvinyl acetal or adding other copolymerization components thereto.

The acetal content (mol % of an acetalized vinyl alcohol unit calculated by regarding the total number of moles of a vinyl acetate monomer as a raw material as being 100%) in the polyvinyl acetal is preferably 30% to 90%, more preferably 50% to 85%, and particularly preferably 55% to 78%.

The content of the vinyl alcohol unit in the polyvinyl acetal is preferably 10 mol % to 70 mol %, more preferably 15 mol % to 50 mol %, and particularly preferably 22 mol % to 45 mol %, with respect to the total number of moles of the vinyl acetate monomer as a raw material.

The polyvinyl acetal may have a vinyl acetate unit as another component, and the content thereof is preferably 0.01 mol % to 20 mol %, and more preferably 0.1 mol % to 10 mol %. The polyvinyl acetal derivative may further have other copolymerization units.

Examples of the polyvinyl acetal include polyvinyl butyral, polyvinyl propyral, polyvinyl ethyral, polyvinyl methyral, and the like. Among these, polyvinyl butyral (PVB) is preferable.

Generally, the polyvinyl butyral is a polymer obtained by butyralizing polyvinyl alcohol. Furthermore, a polyvinyl butyral derivative may be used.

Examples of the polyvinyl butyral derivative include acid-modified PVB in which at least a portion of hydroxyl groups is modified with an acid group such as a carboxyl group; modified PVB in which a portion of hydroxyl groups is modified with a (meth)acryloyl group; modified PVB in which at least a portion of hydroxyl groups is modified with an amino group; modified PVB in which ethylene glycol or propylene glycol and a multimer of these are introduced into at least a portion of hydroxyl groups; and the like.

From the viewpoint of maintaining the balance between the engraving sensitivity and the coating properties, the molecular weight of the polyvinyl acetal, expressed as a weight average molecular weight, is preferably 5,000 to 800,000, and more preferably 8,000 to 500,000. Furthermore, from the viewpoint of improving rinsing properties of the engraving scum, the weight average molecular weight of the polyvinyl acetal is particularly preferably 50,000 to 300,000.

Hereinafter, as particularly preferred examples of the polyvinyl acetal, polyvinyl butyral (PVB) and the derivative thereof will be described, but the present invention is not limited thereto.

PVB is available as a commercial product. Specifically, from the view point of solubility in an alcohol (particularly, solubility in ethanol), for example, an “S-LEC B” series and an “S-LEC K (KS)” series manufactured by SEKISUI CHEMICAL CO., LTD and “DENKA BUTYRAL” manufactured by DENKI KAGAKU KOGYO KABUSHIKI KAISHA are preferable. From the viewpoint of solubility in an alcohol (particularly, ethanol), an “S-LEC B” series manufactured by SEKISUI CHEMICAL CO., LTD and “DENKA BUTYRAL” manufactured by DENKI KAGAKU KOGYO KABUSHIKI KAISHA are more preferable. Particularly, “BL-1”, “BL-1H”, “BL-2”, “BL-5”, “BL-S”, “BX-L”, “BM-S”, and “BH-S” in the “S-LEC B” series manufactured by SEKISUI CHEMICAL CO., LTD and “#3000-1”,“#3000-2”, “#3000-4”, “#4000-2”, “#6000-C”, “#6000-EP”, “#6000-CS”, and “#6000-AS” in the “DENKA BUTYRAL” manufactured by DENKI KAGAKU KOGYO KABUSHIKI KAISHA are preferable.

At the time of forming the recording layer by using PVB as the specific polymer, from the viewpoint of the smoothness of the film surface, a method of casting_{—} solution, which is obtained by dissolving PVB in a solvent, and drying the solution is preferable.

In addition to the polyvinyl acetal and the derivative thereof described above, a polymer which is an acryl resin obtained using a known acryl monomer and has a hydroxyl group in the molecule can also be used as the specific polymer. Furthermore, as the specific polymer, a novolac resin which is a resin obtained by condensing phenols and aldehydes under acidic conditions can also be used. In addition, as the specific polymer, an epoxy resin having a hydroxyl group on the side chain can also be used.

Among the specific polymers, from the viewpoint of the rinsing properties and printing, durability thereof formed into the recording layer, polyvinyl butyral and the derivative thereof are particularly preferable.

The amount of hydroxyl groups contained in the specific polymer is preferably 0.1 mmol/g to 15 mmol/g, and more preferably 0.5 mmol/g to 7 mmol/g, regardless of the type of the polymer.

In the resin composition, one kind of binder may be used singly, or two or more kinds thereof may be used concurrently.

The weight average molecular weight (expressed in terms of polystyrene by GPC analysis) of the binder usable in the present invention is preferably 5,000 to 1,000,000, more preferably 8,000 to 750,000, and most preferably 10,000 to 500,000.

From the viewpoint of satisfying the shape retainability, water resistance, and engraving sensitivity of the coating film in a well balanced fashion, the content of the specific polymer in the resin composition usable in the present invention is preferably 2% by weight to 95% by weight, more preferably 5% by weight to 80% by weight, and particularly preferably 10% by weight to 60% by weight with respect to the total solid contents.

The content of the binder polymer is preferably 5% by weight to 95% by weight, more preferably 15% by weight to 80% by weight, and even more preferably 20% by weight to 65% by weight, with respect to the total weight of the solid contents of the resin composition.

If the content of the binder polymer is equal to or greater than 5% by weight, the obtained printing plate exhibits sufficient printing durability such that it can be used as a printing plate. Furthermore, if the content of the binder polymer is equal to or less than 95% by weight, the amount of other components does not become insufficient, and the printing plate can become flexible enough for being used as a flexo printing plate.

(Solvent)

In the present invention, as the solvent used at the time of preparing the resin composition, from the viewpoint of making the reaction between the compound (I) and the specific polymer proceed rapidly, it is preferable to mainly use a non-protonic organic solvent. More specifically, it is preferable to use solvents at a ratio of non-protonic organic solvent/protonic organic solvent =100/0 to 50/50 (mass ratio). The ratio is more preferably 100/0 to 70/30, and particularly preferably 100/0 to 90/10.

Preferred examples of the non-protonic organic solvent specifically include acetonitrile, tetrahydrofuran, dioxane, toluene, propylene glycol monomethyl ether acetate, methyl ethyl ketone, acetone, methyl isobutyl ketone, ethyl acetate, butyl acetate, ethyl lactate, N,N-dimethylacetamide, N-methylpyrrolidone, and dimethyl sulfoxide.

Preferred examples of the protonic organic solvent specifically include methanol, ethanol, 1-propanol, 2-propanol, 1-butanol, 1-methoxy-2-propanol, ethylene glycol, diethylene glycol, and 1,3-propanediol.

(Polymerization Initiator)

The resin composition preferably contains a polymerization initiator, and more preferably uses an ethylenically unsaturated bond-containing compound concurrently with a polymerization initiator.

As the polymerization initiator, known compounds can be used without limitation. Hereinafter, a radical polymerization initiator as a preferred polymerization initiator will be specifically described, but the present invention is not limited thereto.

The polymerization initiator can be roughly classified into a photopolymerization initiator and a thermal polymerization initiator.

As the photopolymerization initiator, those described above can be suitably used.

In the present invention, from the viewpoint of improving a degree of cross-linking, a thermal polymerization initiator is preferably used. As the thermal polymerization initiator, organic peroxide and an azo-based compound are preferably used, and organic peroxide is more preferably used. Particularly, the following compounds are preferable.

As the radical polymerization initiator usable in the present invention, organic peroxides based on peroxide esters such as 3,3′4,4′-tetra(t-butylperoxycarbonyl)benzophenone, 3,3′4,4′-tetra(t-amylperoxycarbonyl)benzophenone, 3,3′4,4′-tetra(t-hexylperoxycarbonyl)benzophenone, 3,3′4,4′-tetra(t-octylperoxycarbonyl)benzophenone, 3,3′4,4′-tetra(cumylperoxycarbonyl)benzophenone, 3,3′4,4′-tetra(p-isopropylcumylperoxycarbonyl)benzophenone, and di-t-butyldiperoxyisophthalate, t-butylperoxybenzoate are preferable.

Examples of azo-based compounds preferable as the radical polymerization initiator usable in the present invention include 2,2′-azobisisobutyronitrile, 2,2′-azobispropionitrile, 1,1′-azobis(cyclohexane-l-carbonitrile), 2,2′-azobis(2-methylbutyronitrile), 2,2′-azobis(2,4-dimethylvaleronitrile), 2,2′-azobis(4-methoxy-2,4-dimethylvaleronitrile), 4,4′-azobis(4-cyanovalerate), dimethyl 2,2′-azobisisobutyrate, 2,2′-azobis(2-methylpropionamidoxime), 2,2′-azobis[2-(2-imidazolin-2-yl)propane], 2,2′-azobis {2-methyl-N[1,1-bis(hydroxymethyl)-2-hydroxyethyl]propionamide}, 2,2′-azobis [2-methyl-N-(2-hydroxyethyl)propionamide], 2,2′-azobis(N-butyl-2-methylpropionamide), 2,2′-azobis(N-cyclohexyl-2-methylpropionamide), 2,2′-azobis[N-(2-propenyl)-2-methylpropionamide], 2,2′-azobis(2,4,4-trimethylpentane), and the like.

In the present invention, one kind of polymerization initiator may be used singly, or two or more kinds thereof may be used concurrently.

The polymerization initiator can be added preferably in an amount of 0.01% by weight to 10% by weight, and more preferably in an amount of 0.1% by weight to 3% by weight, with respect to the total solid contents of the resin composition.

(Photothermal Conversion Agent)

It is preferable that the resin composition contains a photothermal conversion agent.

The photothermal conversion agent is considered to accelerate the thermal decomposition of the cured layer (recording layer), which is composed of the cured resin composition, by absorbing the light of laser and generating heat. Therefore, it is preferable to select a photothermal conversion agent absorbing light having the wavelength of the laser used for engraving.

In a case where a laser (a YAG laser, a semiconductor laser, a fiber laser, a surface emitting laser, or the like) emitting infrared rays having a wavelength of 700 nm to 1,300 rim is used as a light source for laser engraving, the recording layer in the present invention preferably contains a photothermal conversion agent which can absorb light having a wavelength of 700 nm to 1,300 nm.

As the photothennal conversion agent in the present invention, various dyes and/or pigments are used.

The photothermal conversion agent is more preferably one or more kinds of photothennal conversion agents selected from pigments and dyes having absorption at 800 rim to 1,200 nm.

Furthermore, the photothermal conversion agent is preferably a pigment.

Among the photothennal conversion agents, as dye, commercially available dyes and known dyes described in documents such as “Dye Handbook” (edited by The Society of Synthetic Organic Chemistry, Japan, 1970) can be used. Specific examples thereof include dyes having a maximum absorption wavelength at 700 nm to 1,300 nm, such as an azo dye, a metal complex salt azo dye, pyrazolone azo dye, a naphthoquinone dye, an anthraquinone dye, a phthalocyanine dye, a carbonium dye, a diimonium dye, a quinoneimine dye, a methine dye, a cyanine dye, a squarylium dye, a pyrylium salt, and a metal thiolate complex. Particularly, a cyanine-based dye such as a heptamethine cyanine dye, an oxonol-based dye such as pentamethine oxonol dye, and a phthalocyanine-based dye are preferably used. Examples thereof include the dyes described in paragraphs “0124” to “0137” of JP2008-63554A.

Among the photothermal conversion agents used in the present invention, as pigments, commercially available pigments and the pigments described in the color index (C. I.) handbook, “Latest Pigment Handbook” (edited by The Society of Pigment Technology, Japan, 1977), “Latest Application Technology of Pigment” (published by CMC Publishing Co., Ltd., 1986), and “Printing Ink Technology” (published by CMC Publishing Co., Ltd., 1984) can be used.

Examples of the type of the pigment include a black pigment, a yellow pigment, an orange pigment, a brown pigment, a red pigment, a violet pigment, a blue pigment, a green pigment, a fluorescent pigment, a metal flake pigment, and a polymer binding dye. Specifically, it is possible to use an insoluble azo pigment, an azo lake pigment, a condensed azo pigment, a chelated azo pigment, a phthalocyanine pigment, an anthraquinone-based pigment, and perylene-and perinone-based pigments, a thioindigo-based pigment, a quinacridone-based pigment, a dioxazine-based pigment, an isoindolinone-based pigment, a quinophthalone-based pigment, a dyed lake pigment, an azine pigment, a nitroso pigment, a nitro pigment, a natural pigment, a fluorescent pigment, an inorganic pigment, carbon black, and the like. Among these pigments, carbon black is preferable.

Any type of carbon black including those graded by ASTM can be used regardless of the purpose (for example, carbon black for coloring, rubber, batteries, and the like) as long as the dispersibility thereof in a composition is stable. Carbon black includes, for example, furnace black, thermal black, channel black, lamp black, acetylene black, and the like. Herein, a black colorant such as carbon black is easily dispersed. Therefore, if necessary, carbon black can be used in the form of a color chip or color paste obtained by dispersing the pigment in nitrocellulose or the like by using a dispersant. The chip or paste is easily available as commercial products.

In the present invention, it is also possible to use carbon black, which has a relatively small specific surface area and relatively low DBP absorption, and refined carbon black which has a great specific surface area. Examples of preferred carbon black include PRINTEX (registered trademark) U, PRINTEX (registered trademark) A, and SPEZIALSCHWARZ (registered trademark) 4 (manufactured by Evonik Degussa Co., Ltd).

A dibutyl phthalate (DPB) oil absorption amount of the carbon black usable in the present invention is preferably less than 150 ml/100 g.

From the viewpoint of improving the engraving sensitivity by efficiently transferring heat generated by the photothermal conversion to the surrounding polymer or the like, the carbon black is preferably conductive carbon black whose specific surface area is at least 150 m²/g.

The content of the photothermal conversion agent in the recording layer or the resin composition greatly varies with the magnitude of a molecular extinction coefficient inherent to the molecule of the photothermal conversion agent. However, the content of the photothermal conversion agent is preferably within a range of 0.01% by weight to 20% by weight, more preferably within a range of 0.05% by weight to 10% by weight, and particularly preferably within a range of 0.1% by weight to 5% by weight with respect to the total weight of the solid contents of the resin composition or the recording layer.

(Plasticizer)

It is preferable that the recording layer of the flexo printing plate precursor used in the present invention and the resin composition contain a plasticizer.

The plasticizer functions to soften a film formed of the resin composition. The printing plate prepared by adding the plasticizer can be used for various purposes in which flexibility is required for performing printing (printing performed on a soft packing medium or the like).

The plasticizer needs to be excellently compatible with a polymer.

As the plasticizer, for example, dioctyl phthalate, didodecyl phthalate, tributyl citrate, polyethylene glycols, polypropylene glycol (monol type or diol type), polypropylene glycol (monol type or diol type), and the like are preferably used.

(Other additives)

The resin composition and the recording layer of the flexo printing plate precursor may contain known additives in addition to the components described above.

It is more preferable that nitrocellulose or a highly thermally conductive substance as an additive for improving the engraving sensitivity is added to the resin composition. Being a self-reactive compound, nitrocellulose itself generates heat at the time of laser engraving and assists the thermal composition of the coexisting polymer such as a hydrophilic polymer. Presumably, as a result, the engraving sensitivity may be improved. The highly thermally conductive substance is added for the purpose of assisting the heat transfer, and examples of the thermally conductive substance include an inorganic compound such as metal particles and an organic compound such as a conductive polymer. As the metal particles, fine gold particles, fine silver particles, and fine copper particles having a particle size in order of micrometers to several nanometers are preferable. As the conductive polymer, a conjugated polymer is preferable, and specific examples thereof include polyaniline and polythiophene.

Furthermore, by using a cosensitizer, it is possible to further improve the sensitivity at the time of photocuring the resin composition.

In addition, in order to prevent the polymerizable compound from being unnecessarily thermally polymerized during the manufacturing or preservation of the composition, it is preferable to add a small amount of thermal polymerization inhibitor.

For the purpose of coloring of the resin composition, a colorant such as a dye or a pigment may also be added. If the colorant is added, it is possible to improve the properties such as the visibility of the image portion or the suitability for an image density analyzer.

Moreover, in order to improve the properties of the cured film of the resin composition, a known additive such as a filler may be added.

If necessary, the method for manufacturing a flexo printing plate of the present invention may further include, after the engraving step, the following rinsing step, drying step, and/or post-cross-linking step.

Rinsing step: a step of rinsing the engraved surface of the engraved relief layer with water or a liquid containing water as a main component

Drying step: a step of drying the engraved relief layer

Post-cross-linking step: a step of further cross-linking the relief layer by applying energy to the engraved relief layer

After the engraving step is performed, engraving scum is attached to the engraved surface. Therefore, a rinsing step of washing off the engraving scum by rinsing the engraved surface with water or a liquid containing water as a main component may be added. Examples of means for rinsing include a method of performing rinsing with tap water; a method of spraying water at a high pressure; a method of brushing the engraving surface mainly in the presence of water by using a batch-type or transport-type brush-like rinsing machine known as a developing machine for a photosensitive resin letterpress; and the like. In a case where sliminess of the engraving scum is not removed, a rinsing solution to which soap or a surfactant is added may be used.

In a case where the rinsing step of rinsing the engraved surface is performed, it is preferable to add a drying step of drying the engraved recording layer so as to volatize the rinsing solution.

Furthermore, if necessary, a post-cross-linking step of further cross-linking the engraved recording layer may be added. By performing the post-cross-linking step which is an additional cross-linking step, it is possible to toughen the relief formed by engraving.

The pH of the rinsing solution used in the rinsing step is preferably equal to or greater than 9, more preferably equal to or greater than 10, and even more preferably equal to or greater than 11. Furthermore, the pH of the rinsing solution is preferably equal to or less than 14, more preferably equal to or less than 13.5, and even more preferably equal to or less than 13.1. If the pH is within the above range, it is easy to handle the rinsing solution. In order to make the pH of the rinsing solution fall into the above range, the pH should be appropriately adjusted using an acid and/or a base, and the acid and base used are not particularly limited.

It is preferable that the rinsing solution contains water as a main component. Furthermore, the rinsing solution may contain, as a solvent other than water, a water-miscible solvent such as alcohols, acetone, or tetrahydrofuran.

It is preferable that the rinsing solution contains a surfactant. As the surfactant, from the viewpoint of engraving scum removability and reducing the influence on the flexo printing plate, a betaine compound (amphoteric surfactant) such as a carboxybetaine compound, a sulfobetaine compound, a phosphobetaine compound, an amine oxide compound, or a phosphine oxide compound is preferably exemplified. In the present invention, the N═O structure of an amine oxide compound and the P=0 structure of a phosphine oxide compound are regarded as N⁺—O− and P⁺—O− respectively.

Examples of the surfactant also include known anionic surfactants, cationic surfactants, amphoteric surfactants, nonionic surfactants, and the like. Furthermore, nonionic surfactants based on fluorine and silicone can also be used.

One kind of surfactant may be used singly, or two or more kinds thereof may be used concurrently.

The amount of the surfactant used does not need to be particularly limited. However, it is preferably 0.01% by mass to 20% by mass, and more preferably 0.05% by mass to 10% by mass, with respect to the total mass of the rinsing solution.

From the viewpoint of satisfying various printing suitabilities such as abrasion resistance and ink transferability, the thickness of the relief layer (recording layer) included in the prepared flexo printing plate is preferably equal to or greater than 0.05 mm and equal to or less than 10 mm, more preferably equal to or greater than 0.05 mm and equal to or less than 7 mm, and particularly preferably equal to or greater than 0.05 mm and equal to or less than 3 mm.

The Shore A hardness of the relief layer included in the prepared flexo printing plate is preferably equal to or greater than 50° and equal to or less than 90° . If the Shore A hardness of the relief layer is equal to or greater than 50° , printing can be normally performed without causing the minute dots formed by engraving to be collapsed and crushed due to the strong printing pressure of the letterpress printing machine. Furthermore, if the Shore A hardness of the relief layer is equal to or less than 90° , it is possible to prevent the occurrence of printing blurring in a solid portion even when flexo printing is performed at a kiss-touch printing pressure.

Herein, the Shore A hardness in the present specification is a value measured by a durometer (spring-type rubber hardness tester) which pushes a stylus (referred to as an indenter point or an indenter) into the surface of the measurement target so as to cause deformation, measures the deformation amount (indentation depth), and digitizes the deformation amount.

[Flexo Printing Apparatus]

Next, the constitution of a flexo printing apparatus (hereinafter, simply referred to as a “printing apparatus” as well) using the flexo printing plate according to the present invention will be specifically described. Except for using the flexo printing plate described above, the flexo printing apparatus basically has the same constitution as the flexo printing apparatus of the related art.

FIG. 7 is a view schematically showing main portions of the flexo printing apparatus using the flexo printing plate according to the present invention.

As shown in FIG. 7, a flexo printing apparatus 30 has a flexo printing plate 1 described above, a drum 31, a transport roller 32, an anilox roller 33, a doctor chamber 34, and a circulation tank 35.

The drum 31 has a cylindrical shape, and the flexo printing plate 1 is loaded onto the peripheral surface thereof. While rotating, the drum 31 brings the flexo printing plate 1 into contact with a printing target z.

The transport roller 32 is a roller constituting a transport portion (not shown in the drawing) which transports the printing target z along a predetermined transport path. The transport roller 32 is disposed such that the peripheral surface thereof faces the peripheral surface of the drum 31, and brings the printing target z into contact with the flexo printing plate 1.

The drum 31 is disposed such that the rotation direction thereof becomes identical to the transport direction of the printing target z.

The anilox roller 33, the doctor chamber 34, and the circulation tank 35 are portions for supplying ink to the flexo printing plate 1. The circulation tank 35 stores ink, and the ink in the circulation tank 35 is supplied to the doctor chamber 34 by a pump (not shown in the drawing). The doctor chamber 34 is disposed to come into close contact with the surface of the anilox roller 33 and holds ink in the inside thereof. The anilox roller 33 rotates in synchronization with the drum 31 in a state of coming into contact with the peripheral surface of the drum 31, such that the printing plate 1 is coated (supplied) with the ink in the doctor chamber 34.

While transporting the printing target z along a predetermined transport path, the flexo printing apparatus 30 constituted as above rotates the flexo printing plate 1 loaded onto the drum 31 and transfers the ink to the printing target z, thereby performing printing. That is, the rotation direction of the drum onto which the flexo printing plate is loaded becomes the printing direction.

Herein, in a case where the printing direction at the time of use is preset in the flexo printing plate of the present invention, a constitution may be adopted in which the depression patterns are formed by taking the rear end portion side of the image portion in the printing direction as an end region.

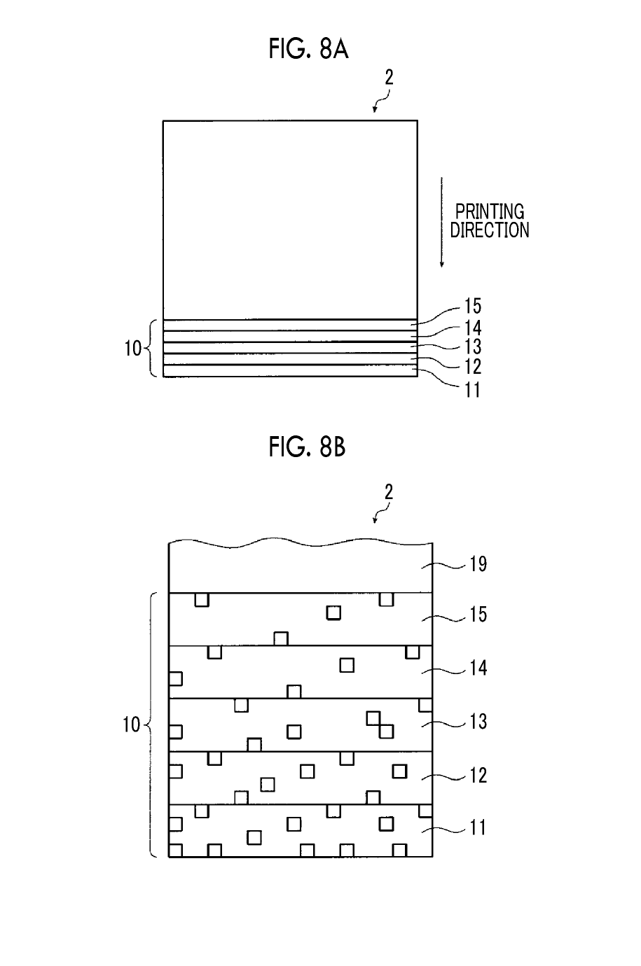

FIG. 8A is a view schematically showing an example of the image portion of the printing plate, and FIG. 8B is a partially enlarged view showing the end region of FIG. 8A through enlargement.

The printing direction of the printing plate shown in FIG. 8A is the vertical direction in the drawing, and the bottom portion of the drawing becomes the rear end portion of the image portion.

As shown in FIG. 8A, the image portion has an end region 10, which consists of 5 partial regions including a first partial region 11 to a fifth partial region 15 from the rear end portion side, in the rear end portion in the printing direction.

As shown in FIG. 8B, depressions in the 5 partial regions are formed such that the area ratio of the depressions becomes maximum in the first partial region 11, decreases as the distance between the partial region and the rear end portion increases, and becomes maximum in the fifth partial region 15.

The type of the printing target used in the flexo printing apparatus using the flexo printing plate of the present invention is not particularly limited, and various known printing targets used in general flexo printing apparatuses, such as paper, films, and cardboards, can be used.

Furthermore, the type of the ink used in the flexo printing apparatus using the flexo printing plate of the present invention is not particularly limited, and various known inks used in general flexo printing apparatuses, such as an aqueous ink, a UV ink, an oil ink, and an EB ink, can be used.

The flexo printing plate (printing apparatus) of the present invention can be more suitably used particularly in combination with a film and an aqueous ink that easily cause rear end voids.

### EXAMPLES

Hereinafter, the present invention will be more specifically described based on examples, but the present invention is not limited thereto.

### <Example 1>

[Printing Plate Precursor for Flexo Engraving]

First, a printing plate precursor for flexo engraving used in Example 1 will be described.

(Resin Composition)

As a binder polymer, DENKA BUTYRAL #3000-2: polyvinyl butyral (Mw =90,000, manufactured by DENKI KAGAKU KOGYO KABUSHIKI KAISHA.) was put into a three-neck flask equipped with a stirring blade and a cooling tube in an amount of 73% by weight with respect to the total weight of the solid contents, and then PGMEA as a solvent was added thereto. The resultant was stirred and heated for 180 minutes at 70° C., thereby dissolving the polymer.

Then, HDDA: hexanediol diacrylate (manufactured by SH1N-NAKAMURA CHEMICAL CO., LTD.) as a polyfunctional monomer was added in an amount of 10% by mass with respect to the total mass of the solid contents; Perbutyl Z: t-butylperoxybenzoate (manufactured by NOF CORPORATION) as a polymerization initiator was added in an amount of 2% by mass with respect to the total mass of the solid contents; and carbon black (trade name: #45L, manufactured by Mitsubishi Chemical Corporation) as a photothermal conversion agent was added in an amount of 15% by mass with respect to the total mass of the solid contents, followed by stirring for 10 minutes. By this operation, a coating solution for a resin layer (resin composition A) having fluidity was obtained.

(Film Formation of Cured Layer)

A spacer frame having a predetermined thickness was installed on a PET substrate, and the resin composition A obtained as above was carefully cast thereonto. The resultant was then heated for 3 hours in an oven at 80° C. and then for 3 hours at 120° C. so as to remove the solvent and cross-link the resin composition. In this way, a cured layer (recording layer) having a thickness of 1.14 mm was obtained.

(Bonding to Support)

The cured layer obtained by film formation was coated with the following adhesive composition at a thickness of 120 μm and bonded to a PET support having a thickness of 0.23 mm through a nip roller. After 20 seconds, from the PET support side, the adhesive was cured by an UV exposure machine (UV exposure machine ECS-151U manufactured by EYE GRAPHICS Co., Ltd., metal halide lamp, 1,500 mJ/cm², exposure for 14 sec) in an exposure amount of 1,000 mJ/cm², thereby preparing a printing plate precursor.

As the adhesive composition, a mixture of 52 parts by mass of 2-hydroxypropyl acrylate (manufactured by OSAKA ORGANIC CHEMICAL INDUSTRY LTD.), 40 parts by mass of trimethylolpropane triacrylate (manufactured by SHIN-NAKAMURA CHEMICAL CO., LTD.), and 8 parts by mass of 1-hydroxycyclohexyl phenyl ketone (manufactured by Ciba Specialty Chemicals Ltd.) was used.

[Preparation of Flexo Printing Plate]

In the flexo printing plate precursor described above, an image portion having an end region provided with depressions was formed by laser engraving, thereby preparing a flexo printing plate.

(Formation Pattern of Depressions)

The formation pattern of depressions in the end region of the image portion was constituted as shown in FIGS. 8A and 8B. Specifically, a 5 mm×5 mm rectangular shape was taken as the image portion, and a region having a width of 500 μm in the rear end portion of the image portion in the printing direction was taken as an end region. In the end region, depressions having an area ratio varying at every width of 100 μm were provided.

The area ratio of the depressions in the region 100 μm distant from the edge was set to be 20%; the area ratio of the depressions in the region 100 μm to 200 μm distant from the edge was set to be 15%; the area ratio of the depressions in the region 200 μm to 300 μm distant from the edge was set to be 10%; and the area ratio of the depressions in the region 300 μm to 400 μm distant from the edge and in the region 400 μm to 500 μm distant from the edge was set to be 5%.

That is, as a constitution in which the image portion has 4 partial regions consisting of the first to third partial regions having a width of 100 μm each and the fourth region having a width of 200 μm, the area ratio of the depressions in the first partial region closest to the edge side was set to be 20%, and the area ratios of the depressions in the second to fourth partial regions were set to be 15%, 10%, and 5% respectively.

The engraving depth of a single depression was set to be 4 μm. Furthermore, the size of a single depression was set to be 15 μm×15 μm, that is, the opening area was set to be 225 μm^{2.}

In addition, in a solid region other than the end region, uniform depressions were formed. The area ratio of the depressions in the solid region was set to be 5%. The shape of the depressions in the solid region was the same as the shape of the depressions formed in the edge.

(Laser Engraving Step)

The flexo printing plate precursor described above was laser-engraved according to the depression patterns described above by using a carbon dioxide laser engraving machine (trademark: ZED-MINI-1000, manufactured by ZED Support Ltd, loaded with a carbon dioxide laser (manufactured by COHERENT) having an output of 2,500 W). The engraving was performed by setting a pitch of 150 LPI/2540 DPI and an engraving depth of 0.50 mm in a non-image portion.

(Rinsing and Drying Step)

The engraved surface of the relief layer having undergone laser engraving was rinsed with a rinsing solution containing water as a main component, and then the engraved relief layer was dried, thereby obtaining a flexo printing plate.

As the rinsing solution, a solution was used which was obtained by adding sodium hydroxide (NaOH, manufactured by Wako Pure Chemical Industries, Ltd.) to pure water so as to prepare an aqueous solution with a pH of 13 and adding 10% by mass of a surfactant: Softazoline LPB-R (manufactured by Kawaken Fine Chemicals Co., Ltd.) and 1% by mass of an antifoaming agent: TSA739(manufactured by TANAC Co., Ltd.) to the alkaline aqueous solution.

[Evaluation]

By using the obtained flexo printing plate, printing was performed, and evaluation was performed regarding the rear end voids, solid density, and inking unevenness.

(Printing Step)

As a printing machine, a 4C printing machine (manufactured by TAIYO KIKAI Ltd.) was used. The obtained printing plate was bonded to a printing plate cylinder (drum) through a cushion tape (manufactured by Loh mane GmbH & Co.KG) and installed in the printing machine. Thereafter, kiss touch (printing pressure at which the entirety of an image starts to be printed) was set to be 0(standard printing pressure), and under a condition in which a printig target was pressed by 40 μm at the set pressure, printing was performed at a printing rate of 150 m/min. The printing target used for evaluation was sampled after being pressed 10,000 times under the aforementioned condition.

As the printing target, a 50 μm OPP film (manufactured by ABE Paper Corporation) was used. Furthermore, as the ink, an aqueous flexo ink, HYDRIC FCF (manufactured by Dainichiseika Color & Chemicals Mfg Co., Ltd.) was used.

(Rear End Voids)

The rear end portion of the image portion in the printing target was observed using a 20× microscope (manufactured by KEYENCE CORPORATION, VHX-1000).

Printing plates in which inking failure hardly occurs in the solid rear end portion were regarded as being excellent in voids. According to the evaluation criteria, a printing plate in which the inking failure was observed in the entire surface in the width direction of the rear end portion was evaluated to be C; a printing plate in which inking failure was intermittently observed was evaluated to be B; a printing plate in which inking failure was substantially not observed was evaluted to be A; and a printing plate in which inking failure was not observed was evaluated to be AA.

(Solid Density)

Within the solid region of the printing target, the density of each of the central portion and both end portions in the width direction was measured at 3 sites by using a densitometer (manufactured by X-Rite Inc.).

Printing plates in which the density was not greatly different from the density of the central portion not being provided with depressions were regarded as being excellent in solid density. According to the evaluation criteria, a printing plate in which a difference beween the average density measured in the central portion and both end portions and the average density measured in the central portion and both end portions not being provided with depressions was equal to or greater than 0.5 was evaluated to be C; a printing plate in which the difference was equal to or greater than 0.2 and less than 0.5 was evaluted to be B; a printing plate in which the difference was equal to or greater than 0.1 and less than 0.2 was evaluated to be A; and a printing plate in which the difference was less than 0.1 was evaluated to be AA.

(Inking Unevenness)

In the printing target, the density of each of the central portion and the rear end portion of the image portion was measured at 3 sites by using a densitometer (manufactured by X-Rite Inc.).

Printing plates in which there was no great difference in the density between the rear end portion and the central portion within the image portion were regarded as being excellent in inking unevenness. According to the evaluation criteria, a printing plate in which the difference of average density measured was equal to or greater than 0.3 was evalauted to be C; a printing plate in which the difference was equal to or greater than 0.2 and less than 0.3 was evaluated to be B; a printing plate in which the difference was equal to or greater than 0.1 and less than 0.2 was evaluated to be A; and a printing plate in which the difference was less than 0.1 was evaluated to be AA.

### <Examples 2 to 20>

Flexo printing plates were prepared and evaluted in terms of the rear end voids, solid density, and inking unevenness in the same manner as in Example 1, except that the shape and area ratio of the depressions were changed as shown in Table 1.

### <Comparative Example 1>

A flexo printing plates was prepared and evaluted in terms of the rear end voids, solid density, and inking unevenness in the same manner as in Example 1, except that depressions were not provided in the image portion.

### <Comparative Examples 2 to 6>

Flexo printing plates were prepared and evalauted in terms of the rear end voids, solid density, and inking unevenness in the same manner as in Example 1, except that the shape and area ratio of the depressions were changed as shown in Table 1.

The formation patterns of the depressions and evlaution results of each of the examples and comparative examples are shown in Table 1.

TABLE 1

| | Shape of | | | | | | | | | | |
|---|---|---|---|---|---|---|---|---|---|---|---|
| | depression | | | Area ratio of depression | | | | | Evaluation | | |
| | Opening | | | End region | | | | | | | Inking |
| | area | Depth | Solid | 400~500 | 300~400 | 200~300 | 100~200 | 0~100 | Rear end | Solid | unevenness |
| | μm² | μm | region | μm | μm | μm | μm | μm | void | density | (continuity) |
| Example 1 | 225 | 4 | 0% | 5% | 5% | 10% | 15% | 20% | AA | AA | AA |
| Example 2 | 25 | 4 | 0% | 5% | 5% | 10% | 15% | 20% | A | AA | AA |
| Example 3 | 2500 | 4 | 0% | 5% | 5% | 10% | 15% | 20% | AA | A | A |
| Example 4 | 225 | 2 | 0% | 5% | 5% | 10% | 15% | 20% | B | AA | AA |
| Example 5 | 225 | 9 | 0% | 5% | 5% | 10% | 15% | 20% | AA | B | B |
| Example 6 | 225 | 4 | 0% | 5% | 5% | 7% | 12% | 20% | AA | AA | AA |
| Example 7 | 225 | 4 | 0% | 5% | 5% | 13% | 18% | 20% | AA | AA | AA |
| Example 8 | 225 | 4 | 0% | 5% | 12% | 7% | 14% | 20% | AA | AA | AA |
| Example 9 | 225 | 4 | 0% | 9% | 13% | 15% | 18% | 20% | AA | AA | A |
| Example 10 | 225 | 4 | 0% | 5% | 5% | 5% | 5% | 11% | A | AA | AA |
| Example 11 | 225 | 4 | 0% | 5% | 5% | 7% | 9% | 11% | A | AA | AA |
| Example 12 | 225 | 4 | 9% | 18% | 27% | 36% | 45% | 54% | AA | A | A |
| Example 13 | 225 | 4 | 9% | 9% | 9% | 10% | 15% | 20% | AA | A | AA |
| Example 14 | 225 | 4 | 5% | 9% | 9% | 9% | 9% | 11% | A | AA | AA |
| Example 15 | 16 | 4 | 0% | 5% | 5% | 10% | 15% | 20% | B | AA | AA |
| Example 16 | 2601 | 4 | 0% | 5% | 5% | 10% | 15% | 20% | AA | B | B |
| Example 17 | 225 | 4 | 0% | 10% | 13% | 15% | 18% | 20% | AA | AA | B |
| Example 18 | 225 | 4 | 0% | 5% | 5% | 7% | 9% | 10% | B | AA | AA |
| Example 19 | 225 | 4 | 9% | 18% | 27% | 36% | 45% | 55% | AA | B | B |
| Example 20 | 225 | 9 | 5% | 5% | 5% | 10% | 15% | 20% | AA | B | A |
| Comparative | — | — | 0% | 0% | 0% | 0% | 0% | 0% | C | AA | AA |
| example 1 | | | | | | | | | | | |
| Comparative | 225 | 1 | 0% | 5% | 5% | 10% | 15% | 20% | C | AA | AA |
| example 2 | | | | | | | | | | | |
| Comparative | 225 | 10 | 5% | 5% | 5% | 10% | 15% | 20% | AA | C | C |
| example 3 | | | | | | | | | | | |
| Comparative | 225 | 4 | 9% | 9% | 9% | 9% | 9% | 9% | C | A | AA |
| example 4 | | | | | | | | | | | |
| Comparative | 225 | 4 | 20% | 20% | 20% | 20% | 20% | 20% | A | C | AA |
| example 5 | | | | | | | | | | | |
| Comparative | 250000 | 4 | 0% | 20% | 20% | 20% | 20% | 20% | A | C | C |
| example 6 | | | | | | | | | | | |

From the results shown in Table 1, it is understood that in a case where printing plates of Examples 1 to 20 having a constitution, in which a plurality of depressions is formed in the end region having a predetermined width measured from the edge within the image portion; the depressions have a depth of 2 μm to 9 μm; and the area ratio of the depressions in the end region is a maximum at the edge side and minimum at the central side of the image portion, were used for printing, it is possible to perform printing that inhibits the occurrence of voids in the rear end portion of the image portion while preventing the decrease in the solid density and prevents discontinuity of density from becoming visible.

From Comparative example 1, it is understood that in a case where depressions are not provided, rear end voids occur. Furthermore, from Comparative examples 4 and 5, it is understood that in a case were uniform depressions are provided in the entire surface of the image portion, the occurrence of the rear end voids cannot be inhibited if the area ratio of the depressions is low, and if the area ratio of the depressions is increased, although the rear end voids are improved, the solid density decreases.

In addition, from Comparative examples 2 and 3, it is understood that in a case where the depth of the depressions is less than 2 μm, the occurrence of the rear end voids cannot be inhibited, and in a case where the depth of the depressions is greater than 9 μm, the solid density decreases.

Moreover, through the comparison between Examples 1 to 3 and Examples 15 and 16, it is understood that by setting the opening area of the depressions to be equal to or greater than 25 μm², the occurrence of the rear end voids can be more suitably inhibited, and by setting the opening area to be equal to or less than 2,500 μm², the decrease in the solid density can be more suitably inhibited. Therefore, it is understood that the opening area of the depressions is more preferably 25 μm² to 2,500 μm^{2.}

Through the comparison bewteen Example 9 and Example 17, it is understood that by setting the difference in the area ratio of the depressions between the partial region at the solid region side and the solid region to be equal to or less than 9%, the occurrence of discontinuity of the density can be more suitably inhibited. Therefore, it is understood that the difference in the area ratio of the depressions between the partial region at the solid region side and the solid region is more preferably equal to or less than 9%.

Through the comparison between Examples 11 and 12 and Examples 18 and 19, it is understood that by setting the area ratio of the depressions in the partial region at the edge side to be equal to or greater than 11%, the occurrence of the rear end void can be more suitably inhibited, and by setting the area ratio to be equal to or less than 54%, the decrease in the solid density can be more suitably inhibited. Therefore, it is understood that the area ratio of the depressions in the partial region at the edge side is more preferably equal to or greater than 11% and equal to or less than 54%.

The above results clearly show the effects of the present invention.

### EXPLANATION OF REFERENCES

1: flexo printing plate

2: image portion

3: non-image portion

10: end region

11: first partial region

12: second partial region

13: third partial region

14: fourth partial region

15: fifth partial region

19: solid region

20: depressions

30: flexo printing apparatus

31: drum

32: transport roller

33: anilox roller

34: doctor chamber

35: circulation tank

z: printing target

What is claimed is:

1. A flexo printing plate comprising:
one or more image portions,
wherein in at least one of the image portions, a plurality of depressions is formed in an end region having a predetermined width measured from the edge,
the depressions have a depth of 2 μm to 9 μm, and
an area ratio of the depressions in the end region is a maximum at the edge side and a minimum at the central side of the image portion.

2. The flexo printing plate according to claim 1,
wherein the width of the end region is 0.1 μm to 600 μm.

3. The flexo printing plate according to claim 1,
wherein in the end region, the area ratio of the depressions decreases in stages as the depressions become further away from the edge.

4. The flexo printing plate according to claim 1,
wherein the width of the end region is 0.1 μm to 600 μm, and
in the end region, the area ratio of the depressions decreases in stages as the depressions become further away from the edge.

5. The flexo printing plate according to claim 1,
wherein each of the depressions has an opening area of 25 μm² to 2,500 μm^{2.}

6. The flexo printing plate according to claim 4,
wherein each of the depressions has an opening area of 25 μm² to 2,500 μm^{2.}

7. The flexo printing plate according to claim 1,
wherein the end region has a plurality of partial regions having different area ratios such that the area ratio of the depressions decreases in stages as the depressions become further away from the edge, and
the area ratio of the depressions in the partial region coming into contact with the edge is equal to or greater than 11% and equal to or less than 54%.

8. The flexo printing plate according to claim 7,
wherein the width of the end region is 0.1 μm to 600 μm.

9. The flexo printing plate according to claim 7,
wherein each of the depressions has an opening area of 25 μm² to 2,500 μm^{2.}

10. The flexo printing plate according to claim 7,
wherein the width of the end region is 0.1 μm to 600 μm, and
each of the depressions has an opening area of 25 μm² to 2,500 μm^{2.}

11. The flexo printing plate according to claim 1,
wherein the end region has a plurality of partial regions having different area ratios such that the area ratio of the depressions decreases in stages as the depressions become further away from the edge, and
a difference in the area ratio of the depressions between partial regions adjacent to each other is equal to or less than 9%.

12. The flexo printing plate according to claim 11,
wherein the width of the end region is 0.1 μm to 600 μm.

13. The flexo printing plate according to claim 11,
wherein each of the depressions has an opening area of 25 μm² to 2,500 μm^{2.}

14. The flexo printing plate according to claim 11,
wherein the width of the end region is 0.1 μm to 600 μm, and
each of the depressions has an opening area of 25 μm² to 2,500 μm^{2.}

15. The flexo printing plate according to claim 7,
wherein the end region has a plurality of partial regions having different area ratios such that the area ratio of the depressions decreases in stages as the depressions become further away from the edge, and
a difference in the area ratio of the depressions between partial regions adjacent to each other is equal to or less than 9%.

16. The flexo printing plate according to claim 10,
wherein the end region has a plurality of partial regions having different area ratios such that the area ratio of the depressions decreases in stages as the depressions become further away from the edge, and
a difference in the area ratio of the depressions between partial regions adjacent to each other is equal to or less than 9%.

17. The flexo printing plate according to claim 1,
wherein the end region is formed at the rear end portion side in a printing direction.

18. The flexo printing plate according to claim 16,
wherein the end region is formed at the rear end portion side in a printing direction.
